(19) United States
(12) Patent Application Publication
(10) Pub. No.: US 2014/0084696 A1
(43) Pub. Date: Mar. 27, 2014

(54) System And Method For Power Transmission In A Bottom Hole Assembly

(71) Applicant: SCHLUMBERGER TECHNOLOGY CORPORATION, Sugar Land, TX (US)

(72) Inventors: Brian Oliver Clark, Sugar Land, TX (US); Keith A. Moriarty, Houston, TX (US); Raphael Gadot, Houston, TX (US)

(73) Assignee: SCHLUMBERGER TECHNOLOGY CORPORATION, Sugar Land, TX (US)

(21) Appl. No.: 13/798,080

(22) Filed: Mar. 13, 2013

Related U.S. Application Data
(60) Provisional application No. 61/704,805, filed on Sep. 24, 2012.
(60) Provisional application No. 61/704,758, filed on Sep. 24, 2012.

(51) Int. Cl. H04B 5/00

(52) U.S. Cl. CPC H04B 5/0037
USPC 307/104

(57) ABSTRACT

Various embodiments of methods and systems for wireless power and data communications transmissions to a sensor subassembly below a mud motor in a bottom hole assembly are disclosed. In a certain embodiment, a float valve is located above the motor. Power is supplied by a turbine or by batteries located in a subassembly above the float valve. Wires pass through the float valve and connect to an annular coil. Power is transmitted through the annular coil to an inductively coupled second, mandrel coil that is attached to the rotor. By leveraging resonantly tuned circuits and impedance matching techniques for the coils, power can be transmitted efficiently from one coil to the other despite relative movement and misalignment of the two coils.

### CROSS-REFERENCE TO RELATED APPLICATIONS

This application claims priority to and the benefit of U.S. Provisional Patent Application Ser. No. 61/704,805, entitled “System And Method for Wireless Power And Data Transmission In A Mud Motor,” and filed on Sep. 24, 2012, and U.S. Provisional Patent Application Ser. No. 61/704,758, entitled “Positive Displacement Motor Rotary Steerable System And Apparatus,” and filed on Sep. 24, 2012, the disclosures of which are hereby incorporated by reference in their entireties.

### DESCRIPTION OF THE RELATED ART

Bottom hole assemblies (“BHA”) at the end of a typical drill string used in the drilling and mining industry today may be a complex assembly of technology that includes not only a drill bit, but also an array of serially connected drill string components or tools. The various drill string tools that make up a BHA commonly include a positive displacement motor or “mud motor” as well as other tools such as, but not limited to, tools that include electrically powered systems on a chip (“SoC”) designed to leverage local sensors for the collection, processing and transmission of data that can be used to optimize a drilling strategy. In many cases, the various tools that make up a BHA are in bidirectional communication. One or more of the tools may serve as a power source for one or more of the other tools.

As one might expect, a BHA may be an equipment assembly with a hardened design that can withstand the demands of a drill string. Failure of a BHA, whether mechanically or electrically, inevitably brings about expensive and unwelcomed operating costs as the drilling process may be halted and the drill string retracted from the bore so that the failed BHA can be repaired. In many cases, retraction of a drill string to repair a failed BHA can range in cost from hundreds of thousands of dollars to millions of dollars.

A common failure point for BHAs is the point of connection from tool to tool, which is naturally prone to failure from adverse fluid ingress and/or misalignment between adjacent tools. While the individual tools may be robust in design, the mechanical and electrical connections between the tools may be a natural “weak point” that often determines the overall reliability of the BHA system.

For instance, in many cases, the transmission of power and/or communications data from and through a positive displacement motor (“PDM”) tool in a BHA is particularly challenging. In common PDMs, power and/or communications data are transmitted via wire which in some applications can be impractical if not impossible. For example, difficulties in transmission by wire might be due to relative motion between adjacent devices in a tool or between adjacent tools in the BHA, the physical distance between two devices or tools, or a wet environment which could lead to short circuiting the electrical power where contacts are used.

### SUMMARY OF THE DISCLOSURE

Various embodiments of methods and systems for wireless power and data communications transmissions to a sensor subassembly in a mud motor are disclosed. The efficient transfer of electrical power between two otherwise weakly coupled coils in a mud motor of a BHA can be accomplished in various embodiments that may leverage resonantly tuned circuits and impedance matching techniques. To compensate for the flux leakage, embodiments resonate inductively coupled primary and secondary coils at the same frequency. Further, in some embodiments, the source resistance is matched to the transmitting coil impedance and the load resistance is matched to the receiving coil impedance.

In a certain embodiment, a float valve is located above the mud motor. Power is supplied by a turbine or by batteries located in a subassembly above the float valve. Wires pass through the float valve and connect to an annular coil. Power is transmitted through the annular coil to an inductively coupled second, mandrel coil that is attached to the rotor of the mud motor (it is envisioned that various embodiments may employ any combination of annular and mandrel coils). By using resonantly tuned circuits and impedance matching techniques for the coils, power may be transmitted efficiently from one coil to the other despite relative movement and misalignment of the two coils. For example, to compensate for flux leakage, embodiments resonate inductively coupled primary and secondary coils at the same frequency.

Additionally, in some embodiments, the source resistance is matched to the transmitting coil impedance and the load resistance is matched to the receiving coil impedance. In some embodiments, a mandrel coil is attached to wires that are routed through a hole in the center of the rotor of the PDM, through a hole in the center of the flex shaft, and through a tube that extends into the bit box of the BHA. At the bit box, an electric connection may be made to a sub containing sensors and electronics. The sub is thus powered by the wires through the mud motor, and communicates with MWD equipment located above the float valve.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass parts having the same reference numeral in figures.

FIG. 1A is a diagram of a system for wireless drilling and mining extenders in a drilling operation;

FIG. 1B is a diagram of a wellsite drilling system that forms part of the system illustrated in FIG. 1A;

FIG. 2 is a schematic drawing depicting a primary or transmitting circuit and a secondary or receiving circuit;

FIG. 3 is a schematic drawing depicting a primary or transmitting circuit and a secondary or receiving circuit with transformers having turn ratios N_{S}:1 and N_{L}:1 that may used to match impedances;

FIG. 4 is a schematic drawing depicting an alternative circuit to that which is depicted in FIG. 3 and having parallel capacitors that are used to resonate the coils' self-inductances;

FIGS. 5A-5B illustrate an embodiment of a receiving coil inside a transmitting coil;

FIGS. 6-7 are graphs illustrating the variation in k versus axial displacement of the receiving coil when x=0 is small and the transverse displacement when z=0 produces very small changes in k of given embodiments, respectively;

FIGS. 8-9 are graphs illustrating that power efficiency may also be calculated for displacements from the center in the z direction and in the x direction, respectively, of given embodiments;

FIG. 10 is a graph illustrating that the sensitivity of the power efficiency to frequency drifts may be relatively small in some embodiments;

FIG. 11 is a graph illustrating that drifts in the components values of some embodiments do not have a large effect on the power efficiency of the embodiment;

FIG. 12 depicts a particular embodiment configured to convert input DC power to a high frequency AC signal, f₀, via a DC/AC convertor;

FIG. 13 depicts a particular embodiment configured to pass AC power through the coils;

FIG. 14 depicts a particular embodiment that includes additional secondary coils configured to transmit and receive data;

FIG. 15 depicts a typical PDM assembly that would be recognized by one of ordinary skill in the art;

FIG. 16 a cross-sectional view of the drill collar, rubber stator, and rotor of the PDM depicted in FIG. 15;

FIG. 17 depicts an embodiment configured to provide power and communications using wires run through the mud motor;

FIG. 18 illustrates a 2 MHz propagation resistivity measurement implemented in a sensor sub located immediately above the drill bit of a BHA; and

FIG. 19 illustrates an embodiment wherein measurement components may be integrated into the bit box such that the sensor sub is the bit box.

### DETAILED DESCRIPTION

The system described below mentions how power and/or communications may flow from the measurement while drilling tool (“MWD”) to a drilling motor. One of ordinary skill in the art recognizes that power and/or communications may easily flow in the other direction—from the drilling motor to the MWD. The inventive system may transmit power and/or communications in either direction and/or in both directions as understood by one of ordinary skill in the art.

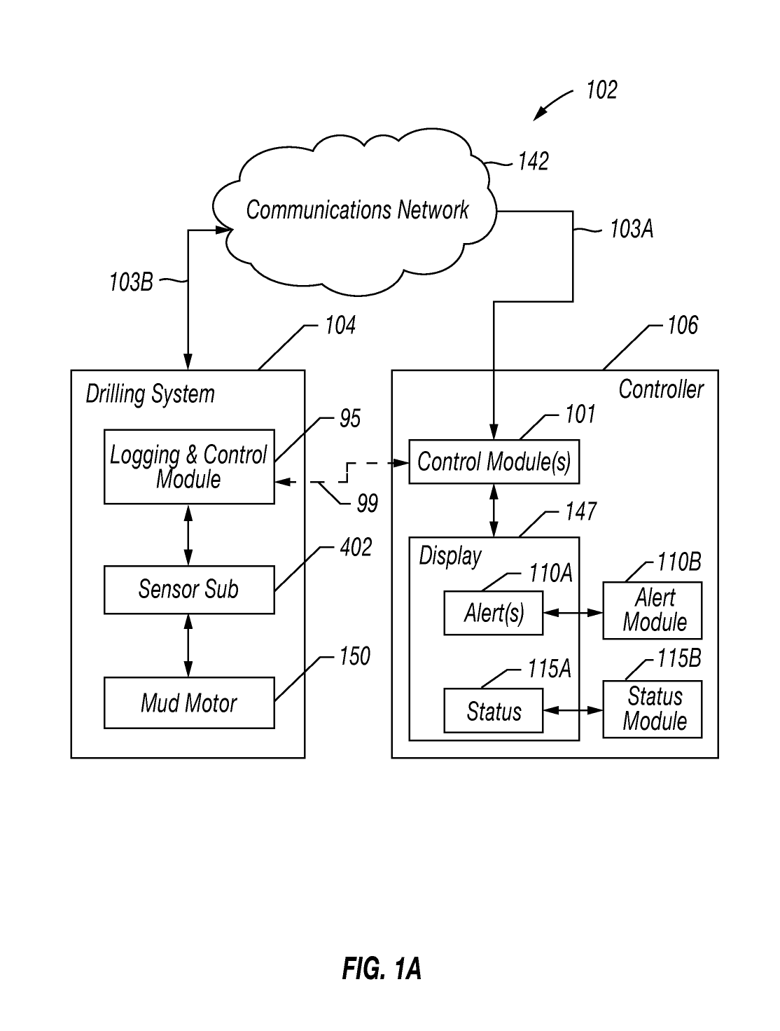

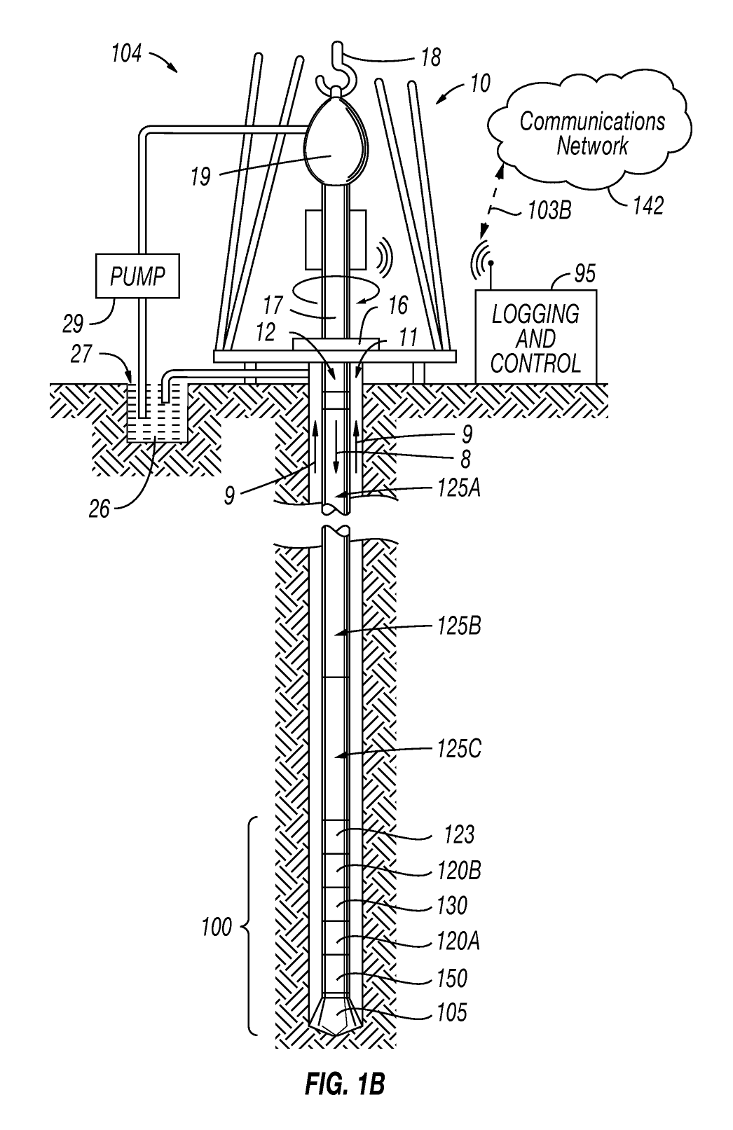

Referring initially to FIG. 1A, this figure is a diagram of a system 102 for controlling and monitoring a drilling operation. The system 102 includes a control module 101 that is part of a controller 106. The system 102 also includes a drilling system 104 which has a logging and control module 95. The controller 106 further includes a display 147 for conveying alerts 110A and status information 115A that are produced by an alerts module 110B and a status module 115B. The controller 106 in some instances may communicate directly with the drilling system 104 as indicated by dashed line 99 or the controller 106 may communicate indirectly with the drilling system 104 using the communications network 142

The controller 106 and the drilling system 104 may be coupled to the communications network 142 via communication links 103. Many of the system elements illustrated in FIG. 1A are coupled via communications links 103 to the communications network 142.

FIG. 1B illustrates a wellsite drilling system 104 that forms part of the system 102 illustrated in FIG. 1A. The wellsite can be onshore or offshore. In this system 104, a borehole 11 is formed in subsurface formations by rotary drilling in a manner that is known to one of ordinary skill in the art. Embodiments of the system 104 can also use directional drilling, as will be described hereinafter. The drilling system 104 includes the logging and control module 95 as discussed above in connection with FIG. 1A.

A drill string 12 is suspended within the borehole 11 and has a bottom hole assembly (“BHA”) 100 which includes a drill bit 105 at its lower end. The surface system includes platform and derrick assembly 10 positioned over the borehole 11, the assembly 10 including a rotary table 16, kelly 17, hook 18 and rotary swivel 19. The drill string 12 is rotated by the rotary table 16, energized by means not shown, which engages the kelly 17 at the upper end of the drill string. The drill string 12 is suspended from a hook 18, attached to a traveling block (also not shown), through the kelly 17 and a rotary swivel 19 which permits rotation of the drill string 12 relative to the hook 18. As is known to one of ordinary skill in the art, a top drive system could alternatively be used instead of the kelly 17 and rotary table 16 to rotate the drill string 12 from the surface. The drill string 12 may be assembled from a plurality of segments 125 of pipe and/or collars threadedly joined end to end.

In the embodiment of FIG. 1B, the surface system further includes drilling fluid or mud 26 stored in a pit 27 formed at the well site. A pump 29 delivers the drilling fluid 26 to the interior of the drill string 12 via a port in the swivel 19, causing the drilling fluid to flow downwardly through the drill string 12 as indicated by the directional arrow 8. The drilling fluid exits the drill string 12 via ports in the drill bit 105, and then circulates upwardly through the annulus region between the outside of the drill string 12 and the wall of the borehole 11, as indicated by the directional arrows 9. In this system as understood by one of ordinary skill in the art, the drilling fluid 26 lubricates the drill bit 105 and carries formation cuttings up to the surface as it is returned to the pit 27 for cleaning and recirculation.

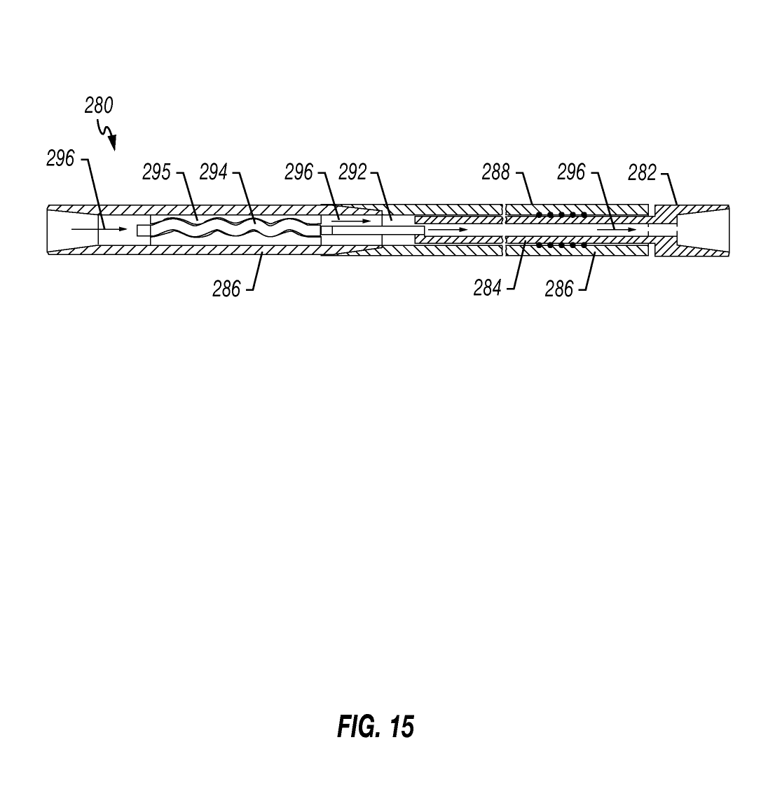

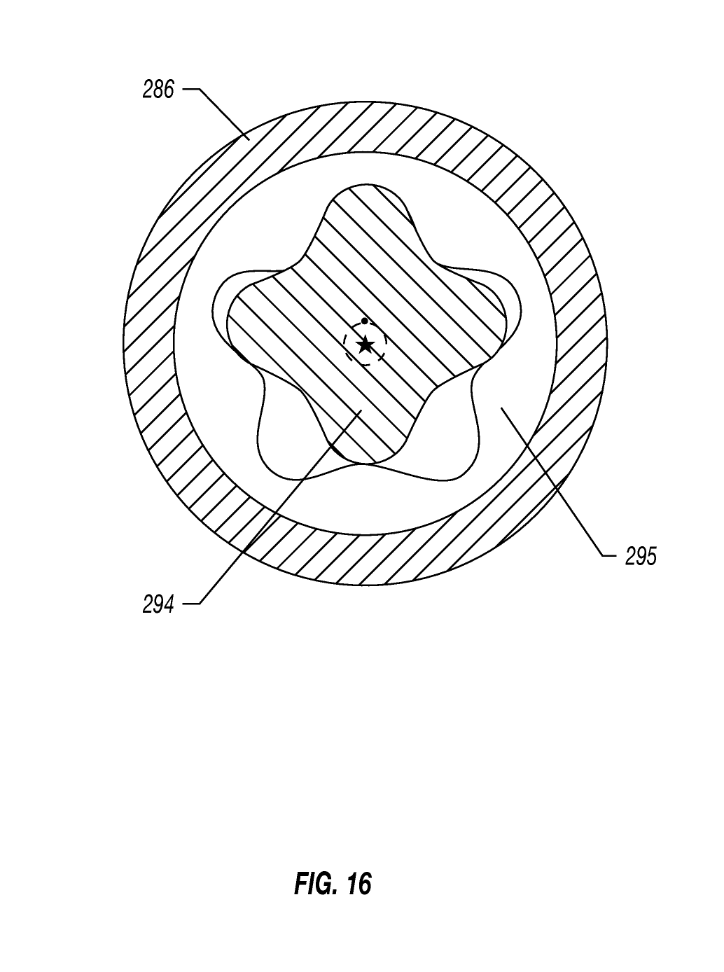

The BHA 100 of the illustrated embodiment may include a logging-while-drilling (“LWD”) module 120, a measuring-while-drilling (“MWD”) module 130, and motor 150 (also illustrated as 280 in FIG. 15 described below), and drill bit 105. The BHA 100 may also include a rotary-steerable system.

The LWD module 120 is housed in a special type of drill collar, as is known to one of ordinary skill in the art, and can contain one or a plurality of known types of logging tools. It will also be understood that more than one LWD 120 and/or MWD module 130 can be employed, e.g. as represented at 120A. (References, throughout, to a module at the position of 120A can alternatively mean a module at the position of 120B as well.) The LWD module 120 includes capabilities for measuring, processing, and storing information, as well as for communicating with the surface equipment. In the present embodiment, the LWD module 120 includes a directional resistivity measuring device.

The MWD module 130 is also housed in a special type of drill collar, as is known to one of ordinary skill in the art, and can contain one or more devices for measuring characteristics of the drill string 12 and drill bit 105. The MWD module 130 may further include an apparatus (not shown) for generating electrical power to the BHA 100.

This apparatus may include a mud turbine generator powered by the flow of the drilling fluid 26, it being understood by one of ordinary skill in the art that other power and/or battery systems may be employed. In the embodiment, the MWD module 130 includes one or more of the following types of measuring devices: a weight-on-bit measuring device, a torque measuring device, a vibration measuring device, a shock measuring device, a stick slip measuring device, a direction measuring device, and an inclination measuring device.

The foregoing examples of wireline and drill string conveyance of a well logging instrument are not to be construed as a limitation on the types of conveyance that may be used for the well logging instrument. Any other conveyance known to one of ordinary skill in the art may be used, including without limitation, slickline (solid wire cable), coiled tubing, well tractor and production tubing.

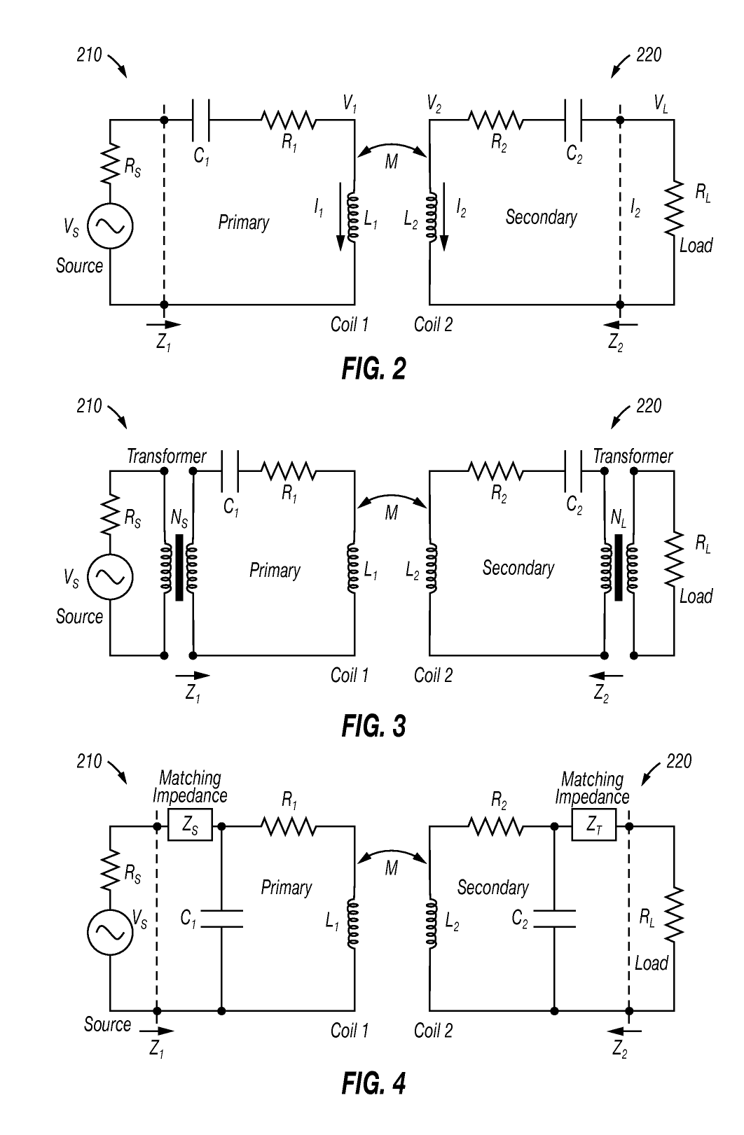

FIG. 2 is a schematic drawing depicting a primary or transmitting circuit 210 and a secondary or receiving circuit 220. In this description, the time dependence is assumed to be exp(jωt) where ω=2πf and f is the frequency in Hertz. Returning to the FIG. 2 illustration, the transmitting coil is represented as an inductance L₁ and the receiving coil as L₂. In the primary circuit 210, a voltage generator with constant output voltage V_{S} and source resistance R_{S} drives a current I₁ through a tuning capacitor C₁ and primary coil having self-inductance L₁ and series resistance R₁. The secondary circuit 220 has self-inductance L₂ and series resistance R₂. The resistances, R₁ and R₂, may be due to the coils' wires, to losses in the coils magnetic cores (if present), and to conductive materials or mediums surrounding the coils. The Emf (electromotive force) generated in the receiving coil is V₂, which drives current I₂ through the load resistance R_{L} and tuning capacitor C₂. The mutual inductance between the two coils is M, and the coupling coefficient k is defined as:

k=M/\sqrt{L₁L₂} (1)

While a conventional inductive coupler has k≈1, weakly coupled coils may have a value for k less than 1 such as, for example, less than or equal to about 0.9. To compensate for weak coupling, the primary and secondary coils in the various embodiments are resonated at the same frequency. The resonance frequency is calculated as:

$${ω}_{0} = \frac{1}{\sqrt{{L}_{1} {C}_{1}}} = \frac{1}{\sqrt{{L}_{2} {C}_{2}}} \qquad ( 2 )$$

At resonance, the reactance due to L₁ is cancelled by the reactance due to C₁. Similarly, the reactance due to L₂ is cancelled by the reactance due to C₂. Efficient power transfer may occur at the resonance frequency, f₀=ω₀/2π. In addition, both coils may be associated with high quality factors, defined as:

$${Q}_{1} = \frac{ω {L}_{1}}{{R}_{1}} \\ and \\ {Q}_{2} = \frac{ω {L}_{2}}{{R}_{2}} . \qquad ( 3 )$$

The quality factors, Q, may be greater than or equal to about 10 and in some embodiments greater than or equal to about 100. As is understood by one of ordinary skill in the art, the quality factor of a coil is a dimensionless parameter that characterizes the coil's bandwidth relative to its center frequency and, as such, a higher Q value may thus indicate a lower rate of energy loss as compared to coils with lower Q values.

If the coils are loosely coupled such that k<1, then efficient power transfer may be achieved provided the figure of merit, U, is larger than one such as, for example, greater than or equal to about 3:

U=k\sqrt{Q₁Q₂}>>1. (4)

The primary and secondary circuits are coupled together via:

V₁=jωL₁I₁+jωMI₂ and V₂=jωL₂I₂+jωMI₁, (5)

where V₁ is the voltage across the transmitting coil. Note that the current is defined as clockwise in the primary circuit and counterclockwise in the secondary circuit. The power delivered to the load resistance is:

$${P}_{L} = \frac{1}{2} {R}_{L} {\vert {I}_{2} \vert}^{2} , \qquad ( 6 )$$

while the maximum theoretical power output from the fixed voltage source V_{S} into a load is:

$${P}_{MAX} = \frac{{\vert {V}_{S} \vert}^{2}}{8 {R}_{S}} . \qquad ( 7 )$$

The power efficiency is defined as the power delivered to the load divided by the maximum possible power output from the source,

$$η ≡ \frac{{P}_{L}}{{P}_{MAX}} . \qquad ( 8 )$$

In order to optimize the power efficiency, η, the source resistance may be matched to the impedance of the rest of the circuitry. Referring to FIG. 2, Z₁ is the impedance looking from the source toward the load and is given by:

$${Z}_{1} = {R}_{1} - j / ( ω {C}_{1} ) + jω {L}_{1} + \frac{{ω}^{2} {M}^{2}}{{R}_{2} + {R}_{L} + jω {L}_{2} - j / ( ω {C}_{2} )} \qquad ( 9 )$$

When ω=ωhd 0, Z₁ is purely resistive and may equal R_{S} for maximum efficiency.

$${Z}_{1} = {R}_{1} + \frac{{ω}^{2} {M}^{2}}{{R}_{2} + {R}_{L}} ≡ {R}_{S} . \qquad ( 10 )$$

Similarly, the impedance seen by the load looking back toward the source is

$${Z}_{2} = {R}_{2} - j / ( ω {C}_{2} ) + jω {L}_{2} + \frac{{ω}^{2} {M}^{2}}{{R}_{1} + {R}_{S} + jω {L}_{1} - j / ( ω {C}_{1} )} \qquad ( 11 )$$

When ω=ω₀, Z₂ is purely resistive and R_{L} should equal Z₂ for maximum efficiency

$${Z}_{2} = {R}_{2} + \frac{{ω}^{2} {M}^{2}}{{R}_{1} + {R}_{S}} ≡ {R}_{L} . \qquad ( 12 )$$

The power delivered to the load is then:

$${P}_{L} = \frac{1}{2} \frac{{R}_{L} {ω}_{0}^{2} {M}^{2} {\vert {V}_{s} \vert}^{2}}{{[ ( {R}_{S} + {R}_{1} ) ( {R}_{2} + {R}_{L} ) + {ω}_{0}^{2} {M}^{2} ]}^{2}} , \qquad ( 13 )$$

and the power efficiency is the power delivered to the load divided by the maximum possible power output,

$$η ≡ \frac{{P}_{L}}{{P}_{MAX}} \frac{4 {R}_{S} {R}_{L} {ω}_{0}^{2} {M}^{2}}{{[ ( {R}_{S} + {R}_{1} ) ( {R}_{2} + {R}_{L} ) + {ω}_{0}^{2} {M}^{2} ]}^{2}} . \qquad ( 14 )$$

The optimum values for R_{L} and R_{L} may be obtained by simultaneously solving

$${R}_{S} = {R}_{1} + \frac{{ω}^{2} {M}^{2}}{{R}_{2 } + {R}_{L}} \\ and \\ {R}_{L} = {R}_{2} + \frac{{ω}^{2} {M}^{2}}{{R}_{1 } + {R}_{S}} , \qquad ( 15 )$$

with the result that:

R_{S}=R₁\sqrt{1+k²Q₁Q₂} and R_{L}=R₂\sqrt{1+k²Q₁Q₂}. (16)

If the source and load resistances do not satisfy equations (16), then it is envisioned that standard methods may be used to transform the impedances. For example, as shown in the FIG. 3 illustration, transformers with turn ratios N_{S}:1 and N_{L}:1 may be used to match impedances as per equations (16). Alternatively, the circuit illustrated in FIG. 4 may be used. In such an embodiment in FIG. 4, parallel capacitors are used to resonate the coils' self-inductances according to equation (2). As before, Z₁ is defined as the impedance seen by the source looking toward the load, while Z₂ is defined as the impedance seen by the load looking toward the source. In addition, there are two matching impedances, Z_{S} and Z_{T} which may be used to cancel any reactance that would otherwise be seen by the source or load. Hence Z₁ and Z₂ are purely resistive with the proper choices of Z_{S} and Z_{T}. Notably, the source resistance R_{S} may equal Z₁, and the load resistance R_{L} may equal Z₂. The procedures for optimizing efficiency with series capacitance or with parallel capacitance may be the same, and both approaches may provide high efficiencies.

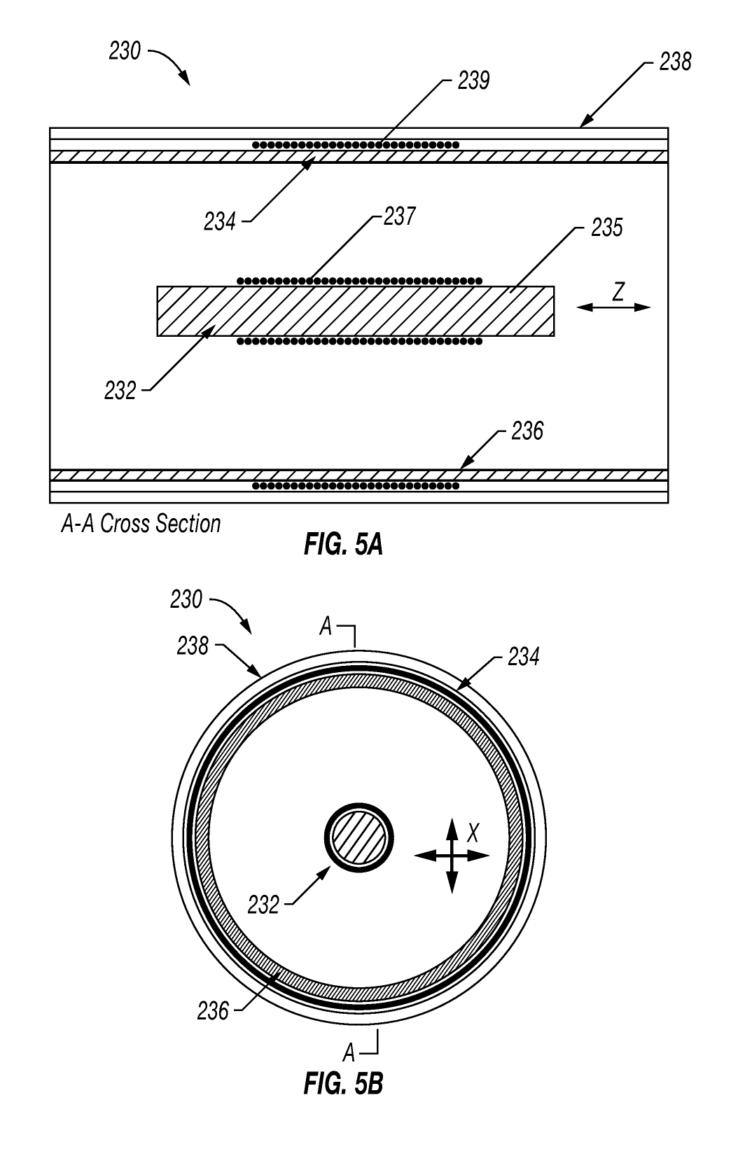

Turning now to FIGS. 5A and 5B, a cross sectional view of two coils 232, 234 is illustrated in FIG. 5A and a side view of the two coils 232, 234 is illustrated in FIG. 5B. In these two figures, a receiving coil 232 inside a transmitting coil 234 of a particular embodiment 230 is depicted. The receiving coil 232 includes a ferrite rod core 235 that, in some embodiments, may be about 12.5 mm (about 0.49 inch) in diameter and about 96 mm (about 3.78 inches) long with about thirty-two turns of wire 237. Notably, although specific dimensions and/or quantities of various components may be offered in this description, it will be understood by one of ordinary skill in the art that the embodiments are not limited to the specific dimensions and/or quantities described herein.

Returning to FIG. 5, the transmitting coil 234 may include an insulating housing 236, about twenty-five turns of wire 239, and an outer shell of ferrite 238. The wall thickness of the ferrite shell 238 in the FIG. 5 embodiment may be about 1.3 mm (about 0.05 inch). In certain embodiments, the overall size of the transmitting coil 234 may be about 90 mm (about 3.54 inch) in diameter by about 150 mm (about 5.90 inches) long. The receiving coil 232 may reside inside the transmitting coil 234, which is annular.

The receiving coil 232 may be free to move in the axial (z) direction or in the transverse direction (x) with respect to the transmitting coil 234. In addition, the receiving coil 232 may be able to rotate on axis with respect to the transmitting coil 234. The region between the two coils 232, 234 may be filled with air, fresh water, salt water, oil, natural gas, drilling fluid (known as “mud”), or any other liquid or gas. The transmitting coil 234 may also be mounted inside a metal tube, with minimal affect on the power efficiency because the magnetic flux may be captured by, and returned through, the ferrite shell 238 of the transmitting coil 234.

The operating frequency for these coils 232, 234 may vary according to the particular embodiment, but, for the FIG. 5 example 230, a resonant frequency f=about 100 kHz may be assumed. At this frequency, the transmitting coil 234 properties are: L₁=6.76·10⁻⁵ Henries and R₁=0.053 ohms, and the receiving coil 232 properties are L₂=7.55·10⁻⁵ Henries and R₂=0.040 ohms. The tuning capacitors are C₁=3.75·10⁻⁸ Farads and C₂=3.36·10⁻⁸ Farads. Notably, the coupling coefficient k value depends on the position of the receiving coil 232 inside the transmitting coil 234. In this example, it can be seen that the receiving coil 232 is centered when x=0 and z=0 and where k=0.64.

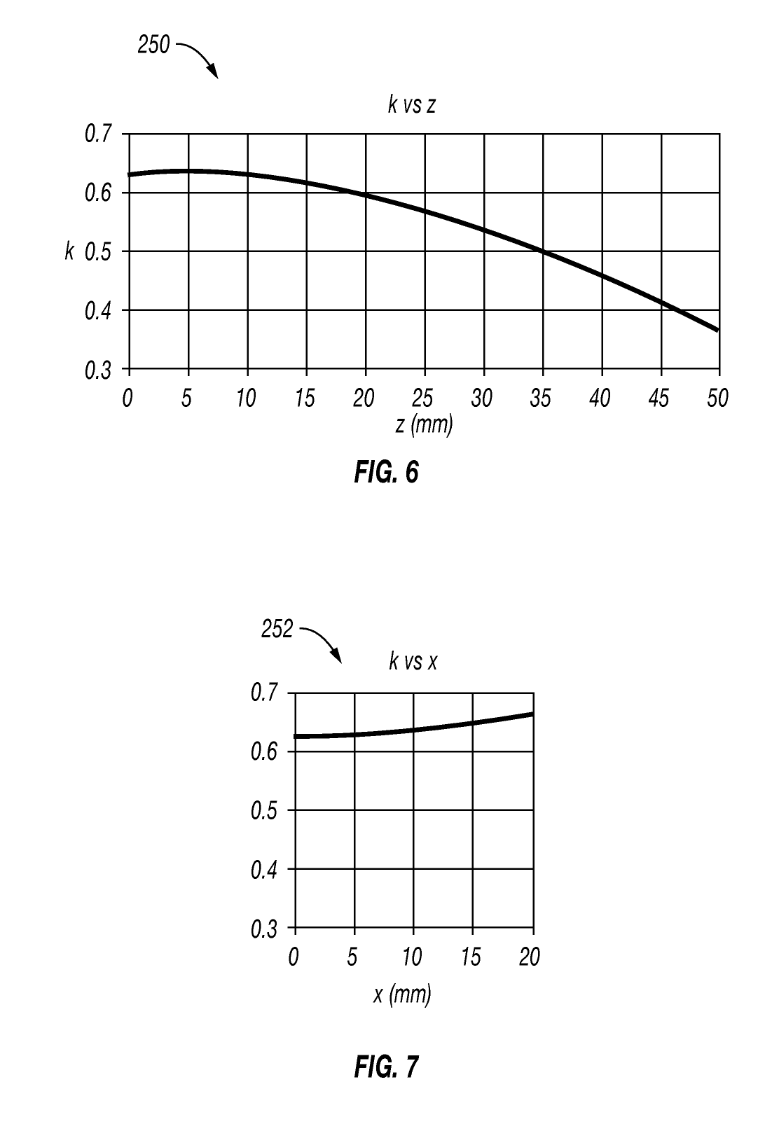

The variation in k versus axial displacement of the receiving coil 232 when x=0 may be relatively small, as illustrated by the graph 250 in FIG. 6. The transverse displacement when z=0 may produce very small changes ink, as illustrated by the graph 252 in FIG. 7. The receiving coil 232 may rotate about the z-axis without affecting k because the coils are azimuthally symmetric. According to equations (16), an optimum value for the source resistance may be R_{S}=32 ohms, and for the load resistance may be R_{L}=24 ohms when the receiving coil 232 is centered at x=0 and z=0. The power efficiency may thus be η=99.5%.

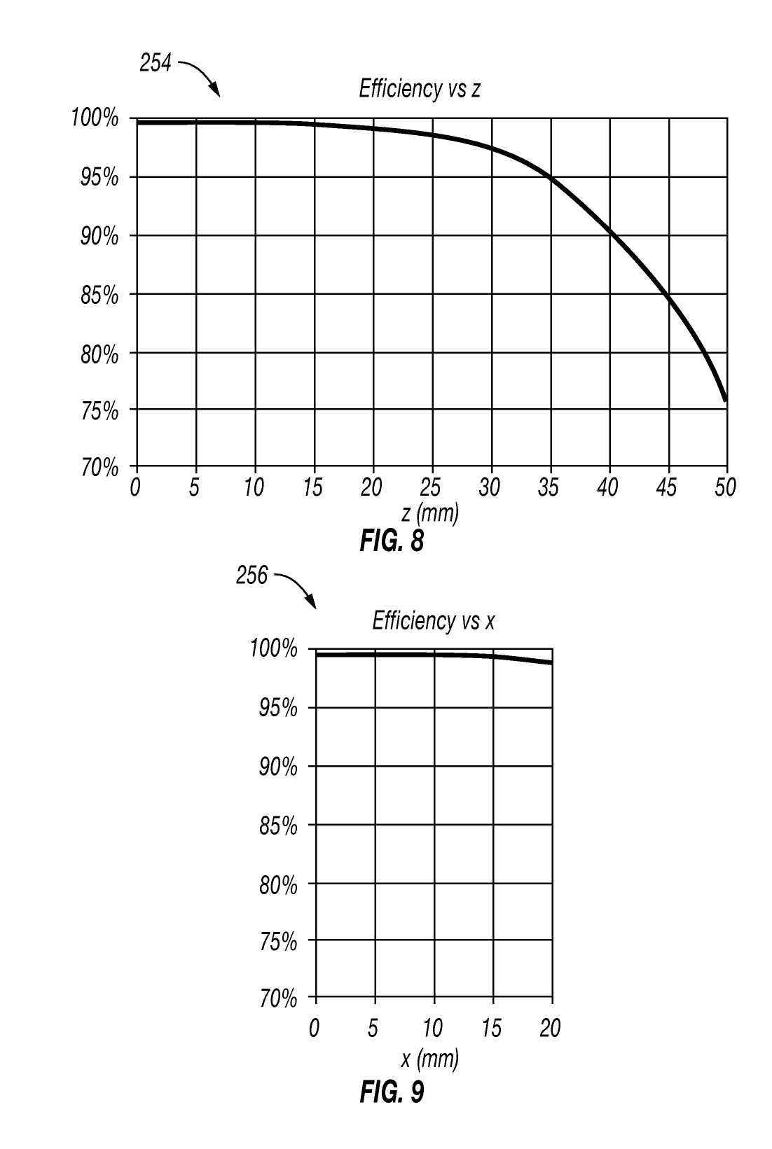

The power efficiency may also be calculated for displacements from the center in the z direction in mm (as illustrated by the graph 254 in FIG. 8) and in the x direction in mm (as illustrated by the graph 256 in FIG. 9). It is envisioned that the efficiency may be greater than about 99% for axial displacements up to about 20.0 mm (about 0.79 inch) in certain embodiments, and greater than about 95% for axial displacements up to about 35.0 mm (about 1.38 inches). It is further envisioned that the efficiency may be greater than 98% for transverse displacements up to 20.0 mm (about 0.79 inch) in some embodiments. Hence, the position of the receiving coil 232 inside the transmitting coil 234 may vary in some embodiments without reducing the ability of the two coils 232, 234 to efficiently transfer power.

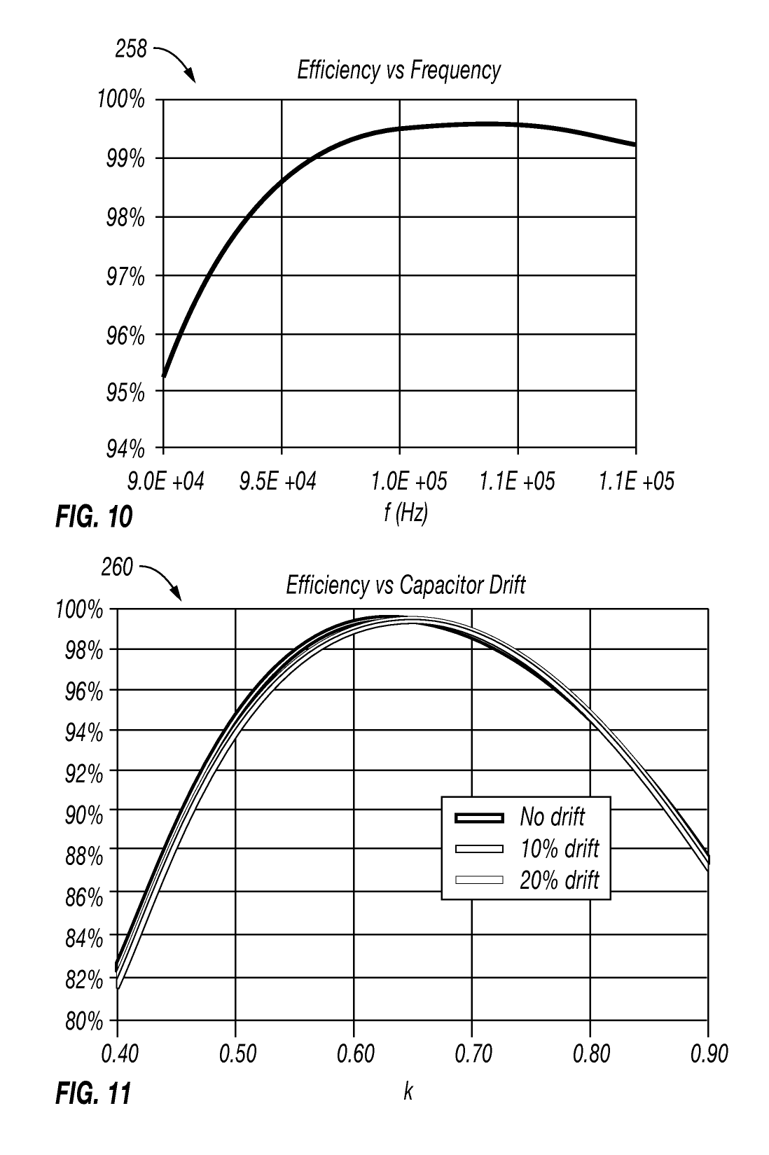

Referring now to FIG. 10, it can be seen in the illustrative graph 258 where the Y-axis denotes efficiency in percentage and the X-axis denotes frequency in Hz that the sensitivity of the power efficiency to frequency drifts may be relatively small. A ±10% variation in frequency may produce minor effects, while the coil parameters may be held fixed. The power efficiency at 90,000 Hz is better than about 95%, and the power efficiency at 110,000 Hz is still greater than about 99%. Similarly, drifts in the component values may not have a large effect on the power efficiency. For example, both tuning capacitors C₁ and C₂ are allowed to increase by about 10% and by about 20% as illustrated in the graph 260 of FIG. 11. Notably, the other parameters are held fixed, except for the coupling coefficient k. The impact of the power efficiency is negligible. As such, the system described herein would be understood by one of ordinary skill in the art to be robust.

It is also envisioned that power may be transmitted from the inner coil to the outer coil of particular embodiments, interchanging the roles of transmitter and receiver. It is envisioned that the same power efficiency would be realized in both cases.

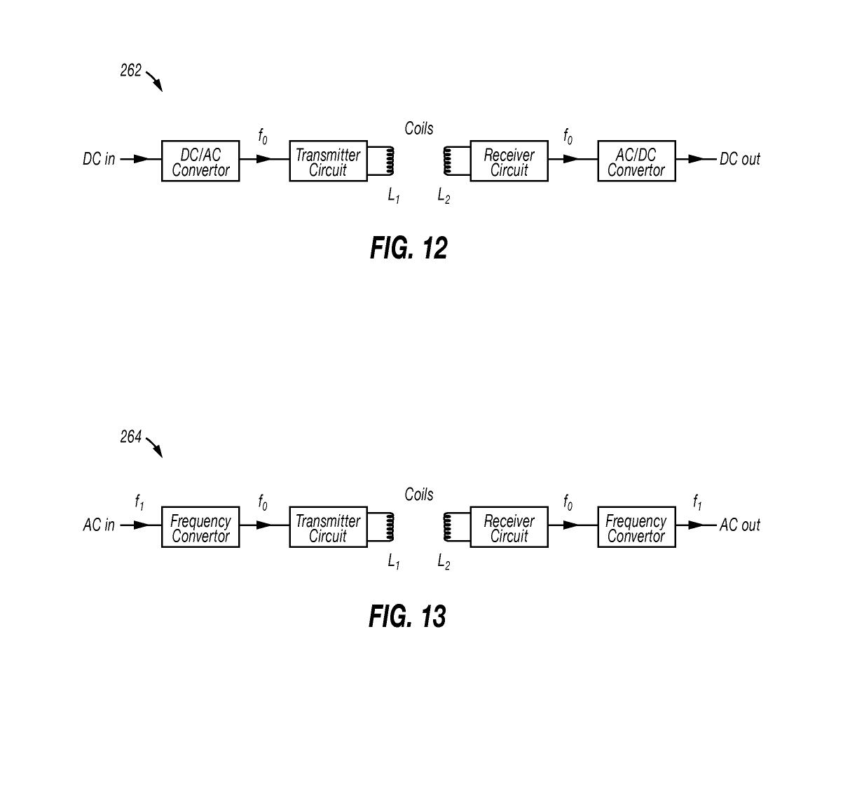

Referring to FIG. 12, an electronic configuration 262 is illustrated for converting input DC power to a high frequency AC signal, f₀, via a DC/AC convertor. The transmitter circuit in the configuration 262 excites the transmitting coil at resonant frequency f₀. The receiving circuit drives an AC/DC convertor, which provides DC power output for subsequent electronics. This system 262 is appropriate for efficient passing DC power across the coils.

Turning to FIG. 13, AC power can be passed through the coils. Input AC power at frequency f₁ is converted to resonant frequency f₀ by a frequency convertor. Normally this would be a step up convertor with f₀>>f₁. The receiver circuit outputs power at frequency f₀, which is converted back to AC power at frequency f₁. Alternatively, as one of ordinary skill in the art recognizes, the FIG. 13 embodiment 264 could be modified to accept DC power in and produce AC power out, and vice versa.

In lieu of, or in addition to, passing power, data signals may be transferred from one coil to the other in certain embodiments by a variety of means. In the above example, power is transferred using an about 100.0 kHz oscillating magnetic field. It is envisioned that this oscillating signal may also be used as a carrier frequency with amplitude modulation, phase modulation, or frequency modulation used to transfer data from the transmitting coil to the receiving coil. Such would provide a one-way data transfer.

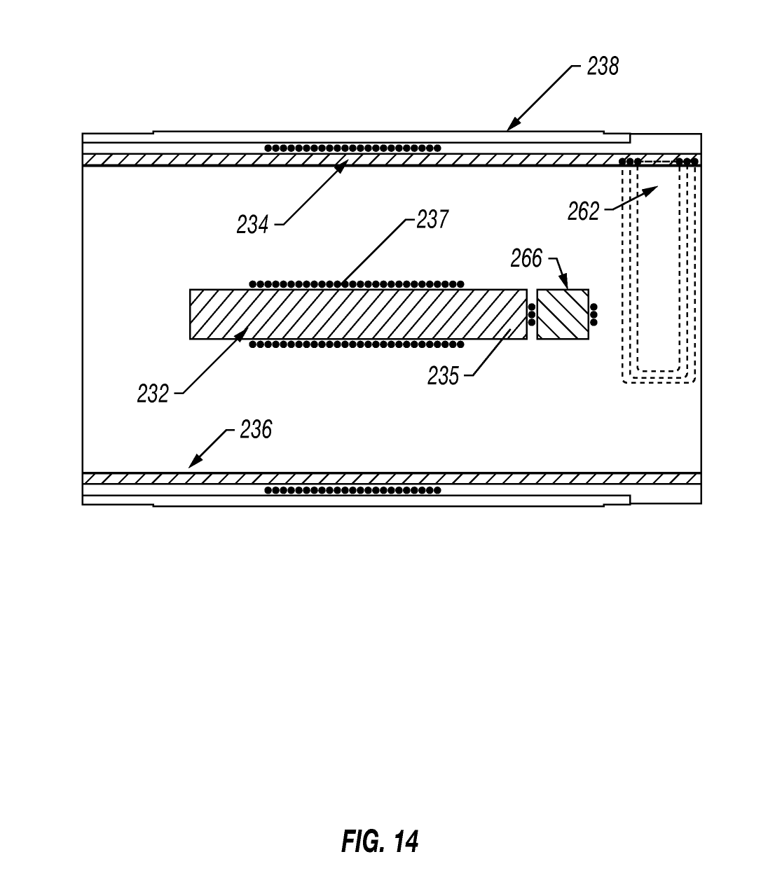

An alternative embodiment includes additional secondary coils to transmit and receive data in parallel with any power transmissions occurring between the other coils described above, as illustrated in FIG. 14. Such an arrangement may provide two-way data communication in some embodiments. The secondary data coils 262, 266 may be associated with relatively low power efficiencies of less than about 10%. It is envisioned that in some embodiments the data transfer may be accomplished with a good signal to noise ratio, for example, about 6.0 dB or better. The secondary data coils 262, 266 may have fewer turns than the power transmitting 234 and receiving coils 232.

The secondary data coils 262, 266 may be orthogonal to the power coils 232, 234, as illustrated in FIG. 14. For example, the magnetic flux from the power transmitting coils 232, 234 may be orthogonal to a first data coil 266, so that it does not induce a signal in the first data coil 266. A second data coil 262 may be wrapped as shown in FIG. 14 such that magnetic flux from the power transmitters does not pass through it, but magnetic flux from first data coil 266 does. Notably, the configuration depicted in FIG. 14 is offered for illustrative purposes only and is not meant to suggest that it is the only configuration that may reduce or eliminate the possibility that a signal will be induced in one or more of the data coils by the magnetic flux of the power transmitting coils. Other data coil configurations that may minimize the magnetic flux from the power transmitter exciting the data coils will occur to those with ordinary skill in the art.

Moreover, it is envisioned that the data coils 262, 266 may be wound on a non-magnetic dielectric material in some embodiments. Using a magnetic core for the data coils 262, 266 might result in the data coils' cores being saturated by the strong magnetic fields used for power transmission. Also, the data coils 262, 266 may be configured to operate at a substantially different frequency than the power transmission frequency. For example, if the power is transmitted at about 100.0 kHz in a certain embodiment, then the data may be transmitted at a frequency of about 1.0 MHz or higher. In such an embodiment, high pass filters on the data coils 262, 266 may prevent the about 100.0 kHz signal from corrupting the data signal. In still other embodiments, the data coils 262, 266 may simply be located away from the power coils 232, 234 to minimize any interference from the power transmission. It is further envisioned that some embodiments may use any combination of these methods to mitigate or eliminate adverse effects on the data coils 262, 266 from the power transmission of the power coils 232, 234.

### Application to Measurements at the Bit in Positive Displacement Motors

As described above, Positive Displacement Motors (“PDM”) or “mud motors” are run in the bottom hole assembly (“BHA”) to increase the revolutions per minute (“RPM”) of the drill bit, or as part of a steerable system when combined with a bent sub. A typical PDM assembly 280 (See also PDM 150 in FIG. 1B) is shown in FIG. 15. The drill bit is attached to a bit box 282, which is attached in turn to a drive shaft 284. The axial load on the drive shaft 284 is transferred to the drill collar 286 by the bearing section 288. The bearing section 288 permits the drive shaft 284 to rotate freely with respect to the drill collar 286. The drive shaft 284 is attached to a flex shaft 292, which is attached to a rotor 294. The drive shaft 284, flex shaft 292 and rotor 294 rotate with respect to the drill collar 286. Drilling fluid (“mud”) flowing through the drill collar 286 provides power to the rotor 294, as represented by the arrows 296.

Referring to FIG. 16, a cross-sectional view of the drill collar 286, rubber stator 295, and rotor 294 of the PDM assembly 280 of FIG. 15 is shown. The mud flows through the mud motor in the spaces between the rubber stator 295 and the rotor 294. As understood by one of ordinary skill in the art, the mud pressure on the spiral grooves in the stator 295 and on the spiral fins on the rotor 294 turns the rotor 294. However, the axis of the rotor 294 is not stationary, but rather orbits in a small circle about the axis of the stator 295. The orbital motion occurs as the fins of the rotor 294 are forced into the grooves of the stator 295. In addition, the rotor 294 may also move in the axial direction as the pressure drop along the rotor 294 changes. Thus the rotor position is constantly changing by a substantial amount with respect to the drill collar 286 (e.g. by centimeters/inches). Referring back to FIG. 15, the flexible steel shaft (flex shaft) 292 attached to the rotor 294 may operate to absorb the variation in the rotor's position.

Mud motors are complex mechanical assemblies that may be 30 feet long or longer. There is very little space available to run wires through the mud motor or to mount sensors or electronics in them. This limits the possibilities for making measurements at the bit, since providing electrical power and communications through the mud motor may be very difficult. Instead, sensors and electronics that are run below the mud motor often may provide their own power supply, which adds length and cost. To communicate past the mud motor, a relatively inefficient and expensive electromagnetic wave transmission system may be used. The electromagnetic waves travel through the formation and are susceptible to losses in a low resistivity formation.

In a steerable system with a bent sub, a relatively short sub may be placed between the bit box and the bit, typically no longer than about 0.61 m (about 2.0 feet). This provides very little space for batteries, antennas, sensors, and electronics in a sensor sub. A major problem with passing power and communications using wires through the mud motor is due to the rotation, orbital and axial motion of the rotor with respect to the drill collar. Wires attached to the upper end of the rotor and connected to the electronics in the drill collar will be subjected to the rotation, orbital and axial movement of the rotor. There may be an electrical connection that allows the wires to rotate, for example a set of slip rings. The slip rings would have to be housed in an oil-filled chamber with rotating O-ring seals. This O-ring system would be an unreliable, costly, and maintenance intensive component. A flexible spring-like structure would also be needed to absorb the orbital and axial motion of the rotor. This would also potentially be an unreliable component due to the constant motion which would fatigue the wires. The two components would also add length to the mud motor, moving the MWD further from the drill bit.

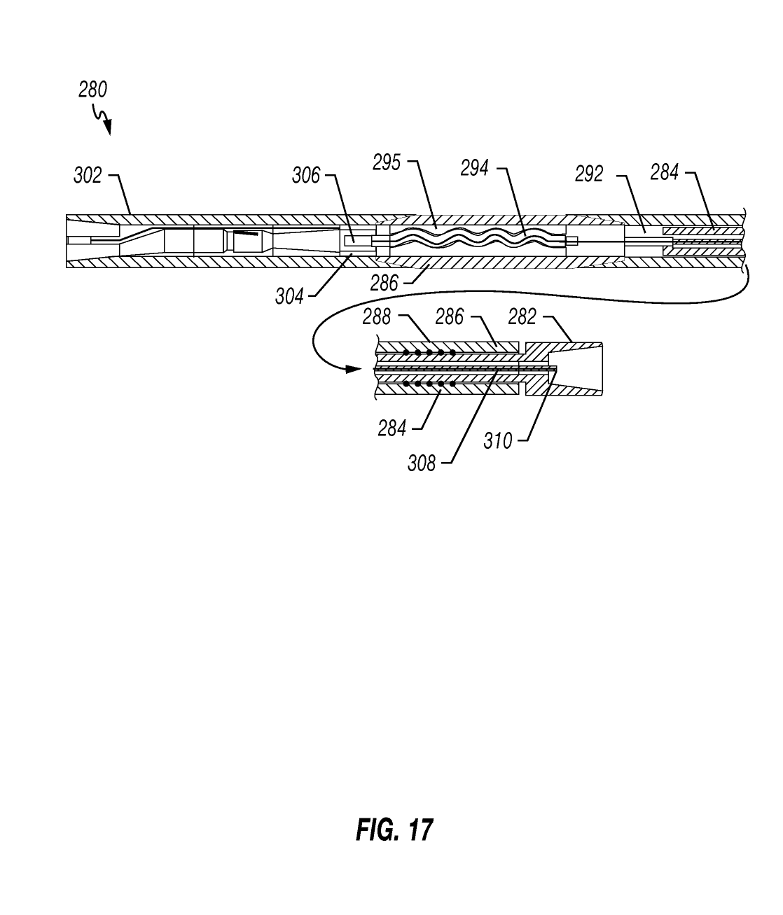

An embodiment for providing power and communications using wires run through the mud motor is shown in FIG. 17. A float valve 302 is located above the rotor 294 and stator 295, as may be done on occasion. This is not a necessary component for all embodiments, but is shown to illustrate a typical configuration. Power is supplied by a turbine or by batteries located in a sub above the float valve (not shown). Wires pass through the float valve and connect to an annular coil 304, for example, such as previously described and as shown in FIGS. 5 and 14. Power is transmitted through the annular coil 304 to a second, mandrel coil 306 that is attached to the rotor 294. As shown in FIGS. 8 and 9, power can be transmitted efficiently from one coil to the other despite relative movement and misalignment of the two coils.

It is envisioned that, in some embodiments, the relative position of the coils 304, 306 may move ±3 cm axially and 2 cm radially without impacting the efficiency for power transfer. Similarly, communications may be provided by a second, smaller set of coils mounted in this region as shown in FIG. 14 (not shown in FIG. 17). The mandrel coil 304 is attached to wires that are routed through a hole in the center of the rotor 294, through a hole in the center of the flex shaft 292, and through a tube 308 that extends into the bit box 282. At the bit box 282, an electric connection 310 may be made to a sub containing sensors and electronics (not shown in FIG. 17). The sub is thus powered by the wires through the mud motor, and communicates with MWD equipment located above the float valve.

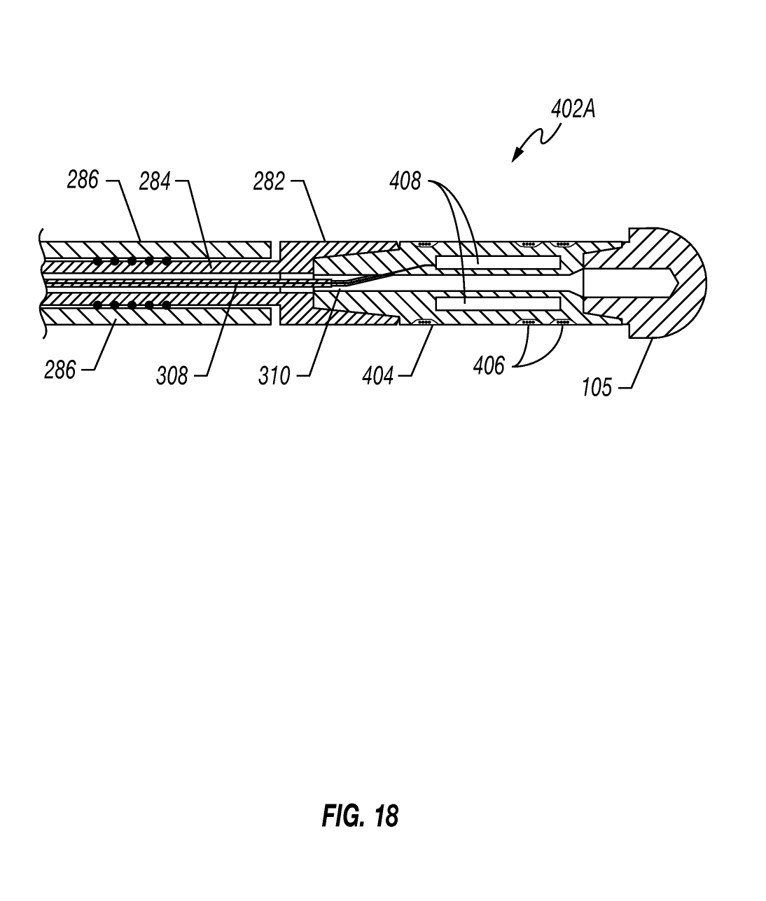

Measurements taken by sensors 408 at the bit may include, but are not limited to, resistivity, gamma-ray, borehole pressure, bit RPM, temperature, shock, vibration, weight on bit, or torque on bit (FIG. 18). FIG. 18 illustrates a 2 MHz propagation resistivity measurement implemented in a sensor sub 402A located immediately above the drill bit 105. A 2 MHz electrometric wave may be generated by the transmitter 404 such that the phase and attenuation of the wave may be measured by two receivers 406. The transmitter 404 and receiver 406 antennas may include wire loops recessed into grooves, as illustrated in the FIG. 18 embodiment. A conventional 2 MHz resistivity measurement may normally located above the mud motor, commonly 20 to 30 feet behind the bit, whereas it is envisioned that this measurement may be taken by certain embodiments downstream from the mud motor near the bit.

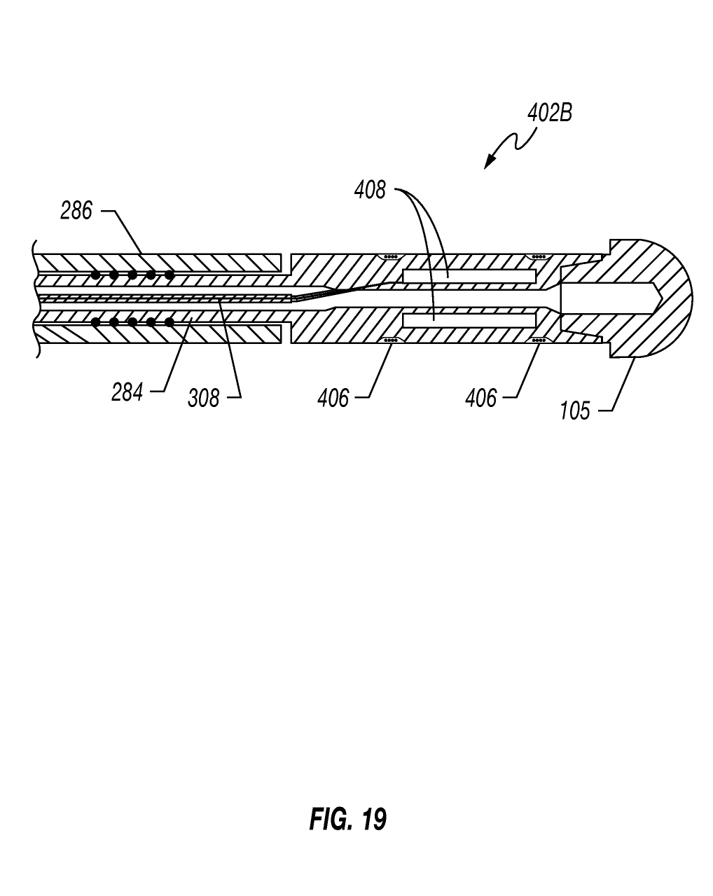

Another envisioned variation (FIG. 19) includes locating two receivers 406 in the sensor sub and placing the transmitter in a separate sub above the mud motor (not shown). The measurement in such an embodiment may be made at a lower frequency, e.g. about 100.0 kHz, and may probe more deeply into the formation. Advantageously, the sensor subassembly 402 is powered by the wires running through the mud motor, eliminating the need for batteries in the sensor subassembly 402. Two way communications between the sensor sub 402 and the MWD system are likewise carried by the wires run through the mud motor. The measurements may also be directly integrated into the bit box 282 as illustrated in FIG. 19 so that the sensor sub 402B is also the bit box 282.

The illustrative embodiments provide for power to be efficiently passed from a tool located above a mud motor to the rotor of the mud motor via two coils. A first coil is annular and located in the ID of the drill collar. The other coil is of a mandrel type and attached to the rotor such that it extends into the annular coil. The coils may be associated with a high Q rating and be resonated at the same frequency. The impedance of the power source is matched to the impedance looking toward the transmitting coil. The impedance of the load is matched to the impedance looking back toward the source.

Advantages of the described method and system include, but are not limited to, the second coil of the two coils being able to rotate and to move in the axial and radial directions without loss of efficiency. According to the inventive method and system, room exits for mud to flow through a space defined between the two coils. Further, power may be transmitted from the tool above the motor to the bit by passing the wires through the rotor.

Various sensors of the described system and method may be located at the bit, powered by the tool located above the mud motor. Measurements at or near the bit may include, but are not limited to, resistivity, gamma-ray, borehole pressure, bit RPM, temperature, shock, vibration, weight on bit, or torque on bit.

Another advantage of the described method and system is that two way communications may be made through the mud motor by adding a second set of coils. Additionally, resistivity measurements at or near the bit may be made by using two coils as receivers, as powered by this inventive system and method.

The described method and system may provide for efficient power transfer. According to one aspect, power may be transmitted between two coils where the two coils do not have to be in close proximity (see equation 1 discussed above) in which k may be less than (<1) or equal to one. Another aspect of the inventive method and system includes resonating the power transmitting coil with a high quality factor (see equation 3 discussed above) in which Q may be greater than (>) or equal to 10. Another aspect of the system and method may include resonating the power transmitting coil with series capacitance (see equation 2 listed above).

Other unique aspects of the described method and system may include resonating the power transmitting coil with parallel capacitance and resonating the power receiving coil with a high quality factor Q (see equation 3) in which Q is greater than (>) or equal to 10. Other unique features of the inventive method and system may include resonating the power receiving coil with series capacitance (see equation 2 discussed above) as well as resonating the power receiving coil with parallel capacitance.

Another unique feature of the described method and system may include resonating the transmitting coil and the receiving coil at similar frequencies (see equation 2 described above) as well as matching the impedance of the power supply to the impedance looking toward the transmitting coil (see equation 10 described above). Another distinguishing feature of the inventive method and system may include matching the impedance of the load to the impedance looking back toward the receiving coil (see equation 12).

An additional distinguishing aspect of the described method and system may include using magnetic material to increase the coupling efficiency between the transmitting and the receiving coils. Further, the inventive method and system may include a power receiving coil that includes wire wrapped around a ferrite core (for example, see FIG. 14). Meanwhile, the power transmitting coil may include a wire located inside a ferrite core (see FIG. 14). According to another aspect, the power transmitting coil may be located inside the power receiving coil (see FIG. 14).

Although a few embodiments have been described in detail above, those skilled in the art will readily appreciate that many modifications are possible in the embodiments without materially departing from this disclosure. Accordingly, such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, sixth paragraph for any limitations of any of the claims herein, except for those in which the claim expressly uses the words ‘means for’ together with an associated function.

What is claimed is:

1. A method for transmitting electrical power from a power source located above a positive displacement motor (“PDM”) in a bottom hole assembly of a drill string to a sensor subassembly located below the PDM in the drill string, the method comprising:
inductively coupling a pair of coils comprising a primary coil and a secondary coil, wherein:
the coils are located above the PDM;
the primary coil is an annular coil and the secondary coil is a mandrel coil extending from a rotor of the PDM;
the secondary coil is substantially positioned within a space defined by the primary coil;
the coils are loosely coupled such that: k=M/\sqrt{L₁L₂}≦0.9, wherein k is the coupling coefficient of the coils, M is the mutual inductance between the coils, and L₁ and L₂ are the self-inductances of the respective coils;
each coil is resonantly tuned with a capacitor such that: f₁≈f₂, wherein
$${f}_{1} \frac{1}{2 π \sqrt{{L}_{1} {C}_{1}}}$$
$$and$$
$${f}_{2} = \frac{1}{2 π \sqrt{{L}_{2} {C}_{2}}}$$
and f₁ and f₂ are the frequencies in Hertz of the respective coils, L₁ and L₂ are the self-inductances of the respective coils, and C₁ and C₂ are capacitances of tuning capacitors associated with the respective coils; and
the coils have an associated figure of merit, U, such that: U=k\sqrt{Q₁Q₂}≧3, wherein
$${Q}_{1} = \frac{2 π {f}_{1} {L}_{1}}{{R}_{1}}$$
$$and$$
$${Q}_{2} = \frac{2 π {f}_{2} {L}_{2}}{{R}_{2}}$$
and Q₁ and Q₂ are the quality factors associated with the respective coils, f₁ and f₂ are the frequencies in Hertz of the respective coils, L₁ and L₂ are the self-inductances of the respective coils, and R₁ and R₂ are the resistances of the respective coils;
providing power from the power source to the primary coil via a wired connection, wherein provision of the power to the primary coil causes power to be transmitted to the inductively coupled secondary coil; and
providing power from the secondary coil to the sensor subassembly via a wired connection that passes through the rotor of the PDM.

2. The method of claim 1, further comprising approximately matching an impedance of the source, R_{S}, with an impedance of a load by setting:
R_{S}≈R₁\sqrt{1+k²Q₁Q₂},
wherein R₁ is the series resistance of the primary coil, k is the coupling coefficient of the pair of coils, Q₁ is the quality factor associated with primary coil and Q₂ is the quality factor associated with the secondary coil.

3. The method of claim 1, further comprising approximately matching an impedance of a load, R_{L}, with an impedance of the source by setting:
R_{L}≈R₂\sqrt{1+k²Q₁Q₂},
wherein R₂ is the series resistance of the secondary coil, k is the coupling coefficient of the pair of coils, Q₁ is the quality factor associated with primary coil and Q₂ is the quality factor associated with the secondary coil.

4. The method of claim 1, wherein the secondary coil comprises a wire wrapped on a core comprised of ferrite.

5. The method of claim 1, wherein the primary coil comprises a wire wrapped inside a cylinder comprised of ferrite.

6. The method of claim 1, wherein the power transferred from the primary coil to the inductively coupled secondary coil comprises data in the form of a modulated amplitude, phase or frequency of a current that drives the primary coil.

7. A method for transmitting electrical power from a power source located above a positive displacement motor (“PDM”) in a bottom hole assembly of a drill string to a sensor subassembly located below the PDM in the drill string, the method comprising:
inductively coupling a pair of coils comprising a primary coil and a secondary coil, wherein:
the coils are located above the PDM;
the primary coil is an annular coil and the secondary coil is a mandrel coil extending from a rotor of the PDM; and
the secondary coil is substantially positioned within a space defined by the primary coil;
providing power from the power source to the primary coil via a wired connection, wherein provision of the power to the primary coil causes power to be transmitted to the inductively coupled secondary coil; and
providing power from the secondary coil to the sensor subassembly via a wired connection that passes through the rotor of the PDM.

8. The method of claim 7, wherein the coupling coefficient, k, of the pair of coils is less than or equal to 0.9.

9. The method of claim 7, further comprising resonantly tuning the pair of coils with a capacitor such that the coils resonate at approximately the same frequency.

10. The method of claim 7, wherein a figure of merit, U, associated with the pair of coils is equal to or greater than 3.

11. The method of claim 7, wherein each of the pair of coils is associated with a high quality factor, Q, that is equal to or greater than 10.

12. The method of claim 7, further comprising approximately matching an impedance of the source, R_{S}, with an impedance of a load by setting:
R_{S}≈R₁\sqrt{1+k²Q₁Q₂},
wherein R₁ is the series resistance of the primary coil, k is the coupling coefficient of the pair of coils, Q₁ is the quality factor associated with primary coil and Q₂ is the quality factor associated with the secondary coil.

13. The method of claim 7, further comprising approximately matching an impedance of a load, R_{L}, with an impedance of the source by setting:
R_{L}≈R₂\sqrt{1+k²Q₁Q₂},
wherein R₂ is the series resistance of the secondary coil, k is the coupling coefficient of the pair of coils, Q₁ is the quality factor associated with primary coil and Q₂ is the quality factor associated with the secondary coil.

14. A system for transmitting electrical power from a power source located above a positive displacement motor (“PDM”) in a bottom hole assembly of a drill string to a sensor subassembly located below the PDM in the drill string, the system comprising:
an inductively coupled pair of coils comprising a primary coil and a secondary coil, wherein:
the coils are located above the PDM;
the primary coil is an annular coil and the secondary coil is a mandrel coil extending from a rotor of the PDM; and
the secondary coil is substantially positioned within a space defined by the primary coil;
a power source coupled to the primary coil via a wired connection and operable to provide power to the primary coil, wherein provision of the power to the primary coil causes power to be transmitted to the inductively coupled secondary coil; and
a wired connection through the rotor of the PDM operable to provide power from the secondary coil to the sensor subassembly.

15. The system of claim 14, wherein the coupling coefficient, k, of the pair of coils is less than or equal to 0.9.

16. The system of claim 14, wherein the pair of coils are resonantly tuned with a capacitor such that the coils resonate at approximately the same frequency.

17. The system of claim 14, wherein a figure of merit, U, associated with the pair of coils is equal to or greater than 3.

18. The system of claim 14, wherein each of the pair of coils is associated with a high quality factor, Q, that is equal to or greater than 10.

19. The system of claim 14, wherein the impedance of the source, R_{S}, is approximately matched with an impedance of a load by setting:
R_{S}≈R₁\sqrt{1+k²Q₁Q₂},
wherein R₁ is the series resistance of the primary coil, k is the coupling coefficient of the pair of coils, Q₁ is the quality factor associated with primary coil and Q₂ is the quality factor associated with the secondary coil.

20. The system of claim 14, wherein the impedance of a load, R_{L}, is approximately matched with an impedance of the source by setting:
R_{L}≈R₂\sqrt{1+k²Q₁Q₂},
wherein R₂ is the series resistance of the secondary coil, k is the coupling coefficient of the pair of coils, Q₁ is the quality factor associated with primary coil and Q₂ is the quality factor associated with the secondary coil.
